(19) United States
(12) Patent Application Publication
(10) Pub. No.: US 2024/0154233 A1
(43) Pub. Date: May 9, 2024

(54) ENERGY STORAGE POWER SUPPLY

(71) Applicant: Fan Zhou, Macheng City (CN)

(72) Inventor: Fan Zhou, Macheng City (CN)

(21) Appl. No.: 18/307,407

(22) Filed: Apr. 26, 2023

(30) Foreign Application Priority Data
Nov. 5, 2022 (CN) 202222942041.5

(51) Int. Cl. H01M 50/284; H01M 10/613; H01M 10/6563; H01M 50/256; H01M 50/258

(52) U.S. Cl. CPC H01M 50/284; H01M 10/613; H01M 10/6563; H01M 50/256; H01M 50/258

(57) ABSTRACT

An energy storage power supply is provided and includes an energy storage power supply. The energy storage power supply includes a detachable mobile power supply socket (9), wherein a front face of the energy storage power supply is configured with a functional panel (20), the functional panel (20) is arranged with a power supply socket box (21), the power supply socket box (21) has a socket receiving slot (17), the mobile power supply socket (9) is detachably mounted in the socket receiving slot (17), and the mobile power supply socket (9) is extractably connected to the energy storage power supply via a wire (18). By arranging the extractable power supply socket box, the power supply socket box can be extracted when the use energy storage power supply is in use, such that the entire energy storage power supply does not need to be moved.

### CROSS REFERENCE TO RELATED APPLICATIONS

The present application claims the priority of the Chinese patent application No. 202222942041.5, filed on 2022 Nov. 5, and the contents of which are incorporated herein by its entireties.

### TECHNICAL FIELD

The present disclosure relates to the field of energy storage power supplies, and in particular to an energy storage power supply.

### BACKGROUND

The energy storage power supply is similar to a mobile power supply. In order to meet market demands, capacity of the energy storage power supply is increasing, and a weight of the energy storage power supply is also increasing, and therefore, the energy storage power supply may be less portable. There are more limitations on using the energy storage power supply outdoors. For example, when the energy storage power supply is large, the energy storage power supply may not be moved conveniently. Especially, when the energy storage power supply is to be used to supply power for a device located far away from the energy storage power supply, generally, the energy storage power supply may be moved to meet the location requirements. When the location where the energy storage power supply is to be used does not have enough space to receive the energy storage power supply, the energy storage power supply may not be used properly. Therefore, when encountering these situations, a conventional energy storage power supply might show various defects.

### SUMMARY OF THE DISCLOSURE

A technical problem to be solved by the present disclosure is to provide an energy storage power supply. When a device to be charged is locating far away from the energy storage power supply, a power supply socket box may be pulled out to meet requirements of the distance, such that the entire mobile power supply may not be moved. In this way, the energy storage power supply may be used easily, and a technical problem of space occupation may not occur.

In an aspect, an energy storage power supply includes an energy storage power supply. The energy storage power supply includes a detachable mobile power supply socket, wherein a front face of the energy storage power supply is configured with a functional panel, the functional panel is arranged with a power supply socket box, the power supply socket box has a socket receiving slot, the mobile power supply socket is detachably mounted in the socket receiving slot, and the mobile power supply socket is extractably connected to the energy storage power supply via a wire.

In some embodiments, a rear of the function panel is arranged with a wiring circuit board, the wiring circuit board is connected to a main control board of the energy storage power supply, the functional panel corresponding to the wiring circuit board is arranged with a host switch key, a DC interface area, a USB interface area, and an AC interface area, a plurality of DC interfaces are arranged within the DC interface area, a plurality of USB interfaces are arranged within the USB interface area, and a plurality of AC interfaces are arranged within the AC interface area.

In some embodiments, the energy storage power supply comprises a power supply housing, a power supply, a main control board, and a wiring circuit board, the wiring circuit board is connected to the main control board, the power supply is connected to the main control board, the power supply, the main control board, and the wiring circuit board are arranged inside the power supply housing, and the extractable wire of the mobile power supply socket is connected to the main control board.

In some embodiments, the mobile power supply socket is arranged with a socket switch button, a socket AC interface area, a socket USB interface area, and a USB-C interface area.

In some embodiments, the mobile power supply socket is further arranged with at least one lamp, and the lamp is controlled by a light switch independently.

In some embodiments, a finger gripping slot is defined on a side of the socket receiving slot.

In some embodiments, a top of the energy storage power supply is arranged with a handle, a cooling area is arranged on each of two sides of the energy storage power supply, a cooling fan is arranged in the cooling area, the cooling fan is connected to and controlled by the main control board, and power is supplied to the cooling fan through the main control board.

According to the present disclosure, the energy storage power supply is arranged with a power supply socket box that can be pulled out of the energy storage power supply to be used. Some socket ports are configured to be movable and extractable. In this way, there is no enough space to receive the energy storage power supply for use or when the device to be charged is locating far away from the energy storage power supply, the power supply socket box may be extracted out of the energy storage power supply for a certain distance, the energy storage power supply may be used normally. In the entire process, the energy storage power supply does not need to be moved, lack of space for using the energy storage power supply properly may be avoided. An overall structure of the energy storage power supply is simple, and configuration of the energy storage power supply is more reasonable.

### BRIEF DESCRIPTION OF THE DRAWINGS

In order to more clearly illustrate the technical solutions in the embodiments of the present disclosure and in the related art, the accompanying drawings used in the description of the embodiments or the related art will be described briefly in the following. Apparently, the accompanying drawings in the following description are only some embodiments of the present disclosure, and other accompanying drawings may be obtained by any ordinary skilled person in the art based on these drawings without any creative work.

FIG. 1 is a structural schematic view of an entire structure of a power supply according to the embodiments of the present disclosure.

FIG. 2 is a structural schematic view of a power supply having a power supply socket box extracted according to the embodiments of the present disclosure.

FIG. 3 is a structural schematic view of an internal structure of a power supply according to the embodiments of the present disclosure.

### DETAILED DESCRIPTION

All features or all operations in a method or a process disclosed in the specification may be combined with each other in any manner, unless the features or the operations are mutually exclusive.

Any feature disclosed in the specification (including any appended claim, the summary and the accompanying drawings) may be replaced by other equivalent or alternative features having a similar purpose, unless specifically specified. That is, unless specifically described, each feature is only one example of a series of equivalent or similar features.

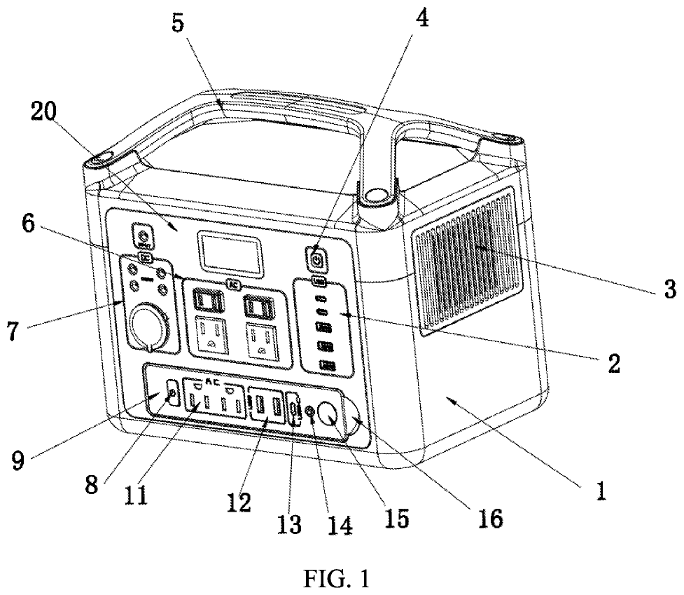

As shown in FIG. 1, the present disclosure provides an energy storage power supply including an energy storage power supply. The energy storage power supply has a detachable mobile power supply socket 9. A front face of the energy storage power supply is configured with a functional panel 20. The functional panel 20 is arranged with a power supply socket box 21. The power supply socket box 21 has a socket receiving slot 17. The mobile power supply socket 9 is detachably mounted in the socket receiving slot 17. The mobile power supply socket 9 is extractably connected to the energy storage power supply via a wire 18.

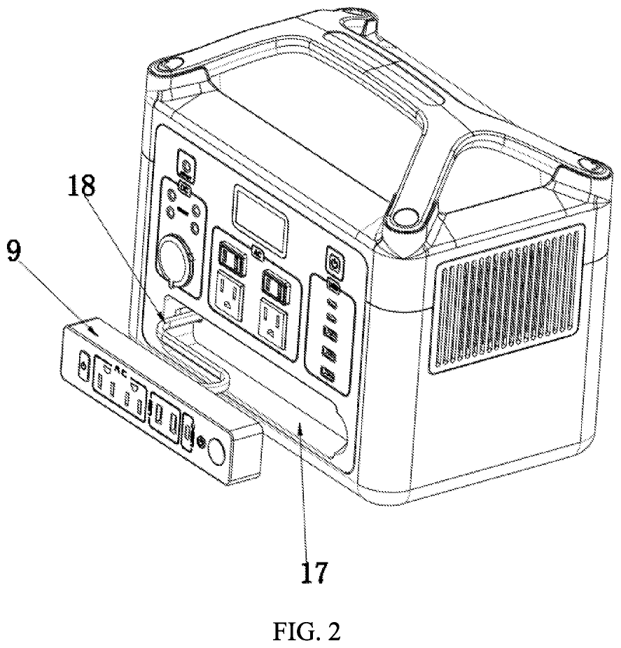

In the present embodiment, the wire may be received in the energy storage power supply by means of an flexible reel. When using the energy storage power supply, only the power supply socket box needs to be extracted, and the wire may be pulled out to reach a desired length. Flexible retraction and extraction can be referred to a extractable self-locking data cable of a mobile phone in the art. Generally, the wire may be pulled, and the wire may be positioned. Further, the wire may be pulled again, and the wire may be retracted. The wire of the present embodiment may be arranged in this manner. After the power supply socket box is extracted, the wire is positioned, as shown in FIG. 2. At this moment, the power supply socket box and the energy storage power supply may be used properly and conveniently. When the energy storage power supply is not used, the power supply socket box may be pulled again, and the wire may be retracted. Of course, other retraction and extraction means, such as a flexible winding wheel, an elastic tension wire, and so on, may be applied in the present embodiment.

As shown in FIG. 1, a rear of the function panel 20 is arranged with a wiring circuit board 25. The wiring circuit board 25 is connected to a main control board 24 of the energy storage power supply. The functional panel corresponding to the wiring circuit board 25 is arranged with a host switch key 4, a DC interface area 7, a USB interface area 2, and an AC interface area 6. A plurality of DC interfaces are arranged within the DC interface area 7. A plurality of USB interfaces are arranged within the USB interface area 2. A plurality of AC interfaces are arranged within the AC interface area 6. Various types of interfaces in the above interface areas are interfaces that are commonly arranged on the energy storage power supply, which will not be described herein in detail.

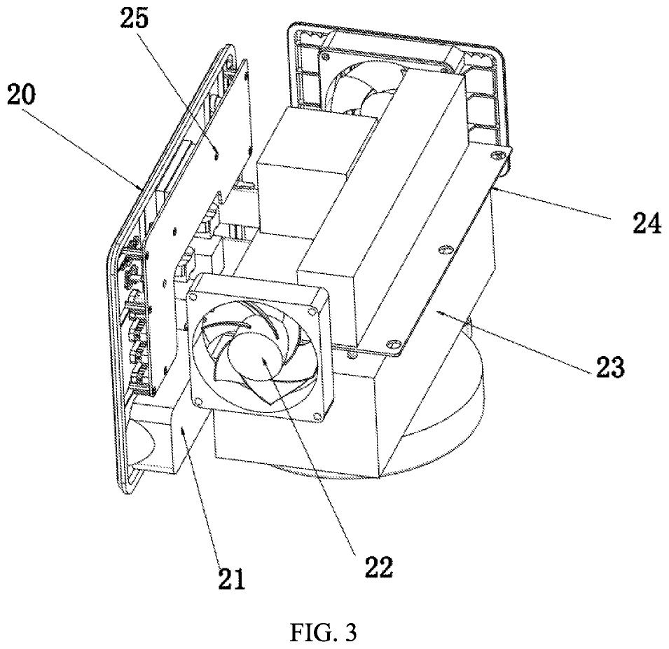

As shown in FIG. 3, the energy storage power supply includes a power supply housing 1, a power supply 23, a main control board 24, and a wiring circuit board 25. The wiring circuit board 25 is connected to the main control board 24. The power supply 23 is connected to the main control board 24. The power supply 23, the main control board 24, and the wiring circuit board 25 are arranged inside the power supply housing 1. The extractable wire 18 of the mobile power supply socket is connected to the main control board 24. The main control board is arranged with a charging interface configured to charge the power supply, and the wiring circuit board is arranged with various types of interfaces.

In the present embodiment, the mobile power supply socket 9 is arranged with a socket switch button 8, a socket AC interface area 11, a socket USB interface area 12, and a USB-C interface area 13. A structure of the mobile power supply socket is the same as that of a conventional power supply socket in the art. In the present disclosure, some of the interfaces, which may be arranged on a main body portion of the mobile power supply traditionally, are now arranged on the movable power supply socket. In this way, the entire mobile power supply socket may be extracted out when needed, just like using a multifunctional socket at home, which is quite convenient. Only the mobile power supply socket needs to be extracted, whereas the energy storage power supply does not need to be moved.

In order to allow the energy storage power supply to be more suitable for outdoor usage, the mobile power supply socket 9 is further arranged with at least one lamp 15. The lamp 15 is controlled by a light switch 14 independently. When an ambient light is not enough while the energy storage power supply is being used, the mobile power supply socket may be extracted, and the lamp may be turned on, such that the lamp may be used as a torch to illuminate a flexible range. Of course, when the mobile power supply socket is fixed on the energy storage power supply, the illuminous lighting function may also be achieved. In this way, an application scenario of the energy storage power supply may be expanded, and the energy storage power supply may be used flexibly.

In order to allow the socket receiving slot to be accessed easily, a finger gripping slot 16 is defined on a side of the socket receiving slot 17.

In the present embodiment, the mobile power supply socket and the energy storage power supply may be connected to each other through magnetic attraction, fastening, and so on. The magnetic attraction may be preferred, since magnetic attraction connection allows the mobile power supply socket to be detached from and attached to the energy storage power supply more easily. In practice, a series of portable detachable means, such as snapping detachment, may be arranged.

A top of the energy storage power supply is arranged with a handle 5, such that the energy storage power supply may be easily lifted and carried. A cooling area 3 is arranged on each of two sides of the energy storage power supply. A cooling fan 22 is arranged in the cooling area 3. The cooling fan 22 is connected to and controlled by the main control board 24, and power is supplied to the cooling fan 22 through the main control board 24. The cooling fan is configured to dissipate heat when the energy storage power supply is in use.

The above shows only specific implementation of the present disclosure, but the scope of the present disclosure is not limited to the above description. Any change or substitution made without creative work shall be covered by the scope of the present disclosure. Therefore, the scope of the present disclosure shall be subject to the scope defined by the claims.

What is claimed is:

1. An energy storage power supply, comprising an energy storage power supply, the energy storage power supply comprising a detachable mobile power supply socket, wherein a front face of the energy storage power supply is configured with a functional panel, the functional panel is arranged with a power supply socket box, the power supply socket box has a socket receiving slot, the mobile power supply socket is detachably mounted in the socket receiving slot, and the mobile power supply socket is extractably connected to the energy storage power supply via a wire.

2. The energy storage power supply according to claim 1, wherein a rear of the function panel is arranged with a wiring circuit board, the wiring circuit board is connected to a main control board of the energy storage power supply, the functional panel corresponding to the wiring circuit board is arranged with a host switch key, a DC interface area, a USB interface area, and an AC interface area, a plurality of DC interfaces are arranged within the DC interface area, a plurality of USB interfaces are arranged within the USB interface area, and a plurality of AC interfaces are arranged within the AC interface area.

3. The energy storage power supply according to claim 1, wherein the energy storage power supply comprises a power supply housing, a power supply, a main control board, and a wiring circuit board, the wiring circuit board is connected to the main control board, the power supply is connected to the main control board, the power supply, the main control board, and the wiring circuit board are arranged inside the power supply housing, and the extractable wire of the mobile power supply socket is connected to the main control board.

4. The energy storage power supply according to claim 1, wherein the mobile power supply socket is arranged with a socket switch button, a socket AC interface area, a socket USB interface area, and a USB-C interface area.

5. The energy storage power supply according to claim 1, wherein the mobile power supply socket is further arranged with at least one lamp, and the lamp is controlled by a light switch independently.

6. The energy storage power supply according to claim 1, wherein a finger gripping slot is defined on a side of the socket receiving slot.

7. The energy storage power supply according to claim 1, wherein a top of the energy storage power supply is arranged with a handle, a cooling area is arranged on each of two sides of the energy storage power supply, a cooling fan is arranged in the cooling area, the cooling fan is connected to and controlled by the main control board, and power is supplied to the cooling fan through the main control board.

8. The energy storage power supply according to claim 4, wherein the mobile power supply socket is further arranged with at least one lamp, and the lamp is controlled by a light switch independently.
